(19) United States
(12) Patent Application Publication
(10) Pub. No.: US 2009/0149279 A1
(43) Pub. Date: Jun. 11, 2009

(54) Titlable portable baseball tee with stowable handle and bucket retainer

(76) Inventors: Sandra Kay Fischer, Stillwater, OK (US); H. Kenneth Lewis, Surprise, AZ (US)

Correspondence Address: TOD R NISSLE, PO BOX 55630, PHOENIX, AZ, 85078, US

(21) Appl. No.: 12/288,232

(22) Filed: Oct. 17, 2008

Related U.S. Application Data
(60) Provisional application No. 60/999,456, filed on Oct. 19, 2007.

(51) Int. Cl. A63B 69/00; B62B 1/12

(52) U.S. Cl. 473/417; 280/47.26; 473/451

(57) ABSTRACT

A tiltable portable baseball tee unit is provided. The unit includes a base shaped to seat removably a bucket; includes a hitting tee assembly; and, includes a handle assembly. The base is mounted on a wheel-axle assembly such that the handle assembly can be used to tilt the base and hitting tee onto the axle and wheel and to pull the baseball tee to a desired location. The handle assembly and the hitting tee assembly can be folded into stored configurations to facilitate storage of the unit.

This application claims priority based on provisional patent application Ser. No. 60/999,456 filed Oct. 19, 2007.

This invention relates to baseball equipment.

More particularly, the invention relates to baseball equipment utilized to practice hitting and other facets of the game of baseball. As used herein and as commonly understood, baseball includes hardball and softball.

Hitting tees have long been utilized in baseball, as have buckets in which baseballs are collected to be used in hitting, fielding, throwing, and other drills utilized to practice to play the game of baseball. The Easton tee bucket comprises a bucket with a hitting tee attached to the bucket. Baseballs or other practice balls are stored in the bucket. However, the Easton tee bucket is not believed to be constructed such that an actual baseball can be hit off the tee. The bucket appears to be constructed for use with lightweight practice balls. The Easton tee bucket can be seen on the Internet at the web sites of Sports Authority, Dick's Sporting Goods, and other sporting goods retailers. A hitting tee typically comprises a square or home-plate-shaped base with an elongate telescoping neck mounted on and extending upwardly from the base. The top of the neck is shaped such that a baseball seats on and can be hit off the neck. Baseball coaches and players carry hitting tees and buckets from location to location.

We have discovered a new apparatus that facilitates the transport and use of a hitting tee, of a bucket, and of baseballs stored in the bucket.

Further and more specific objects and advantages of the invention will be apparent to those skilled in the art from the following detailed description thereof, taken in conjunction with the drawings, in which:

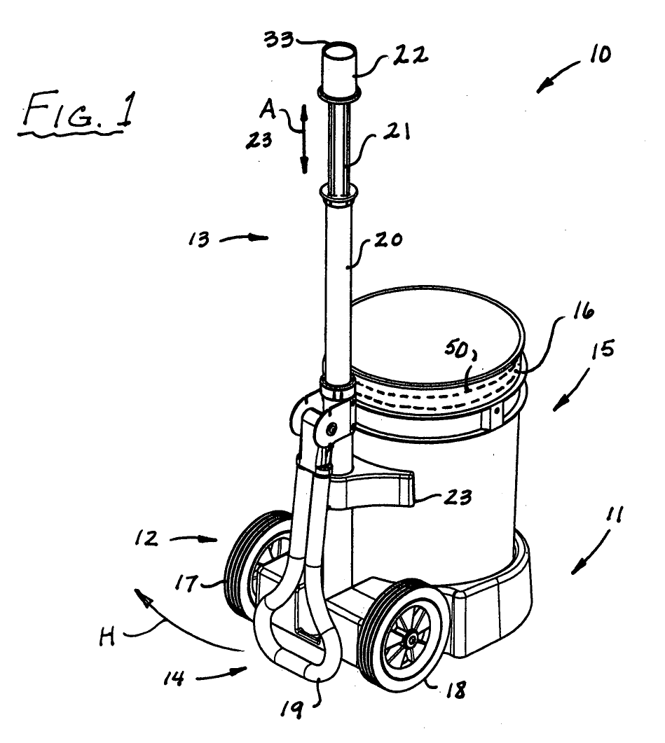

FIG. 1 is a perspective view illustrating a tiltable portable baseball tee with a stowed handle and bucket retainer and constructed in accordance with the principles of the invention;

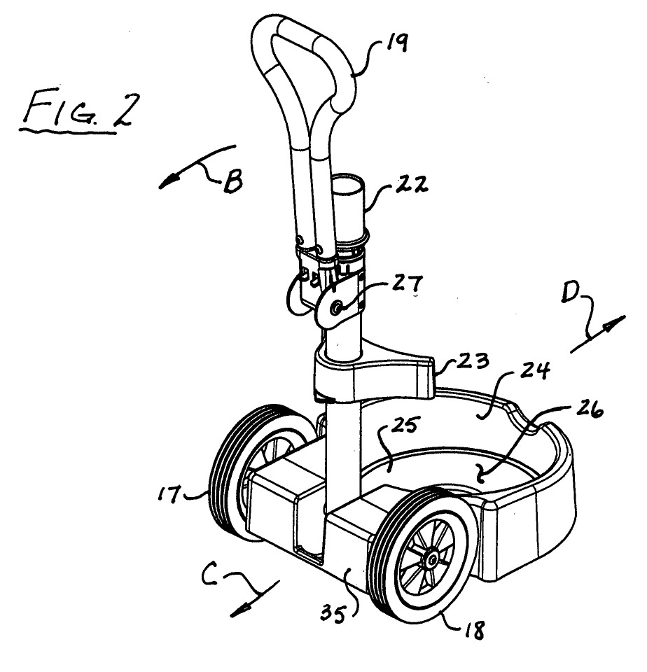

FIG. 2 is a perspective view illustrating the tiltable portable baseball tee of FIG. 1 with the handle deployed and with the bucket removed;

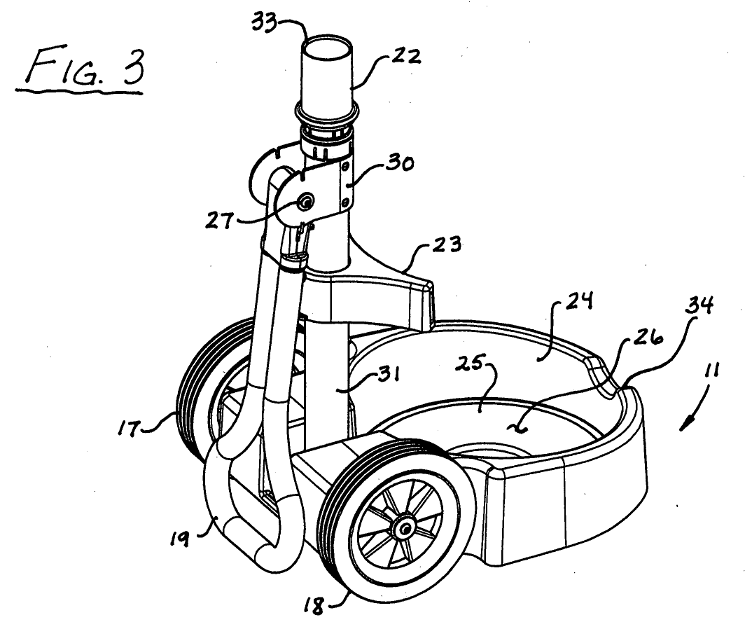

FIG. 3 is a perspective view illustrating the tiltable portable baseball tee of FIG. 1 with the bucket removed and with the handle stowed;

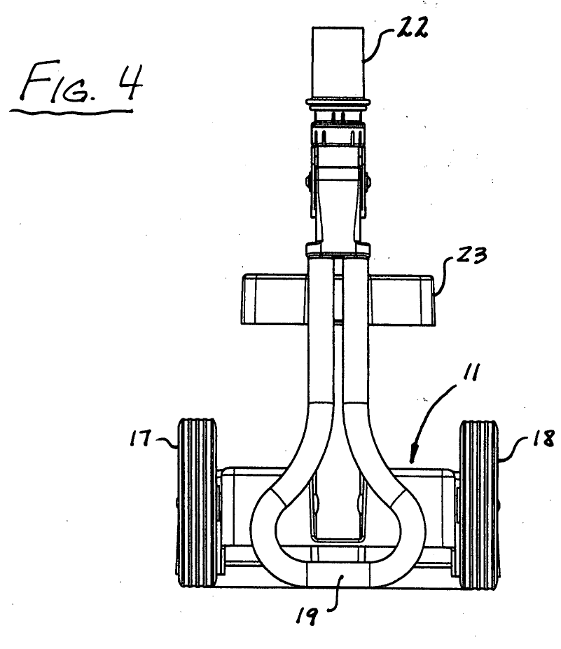

FIG. 4 is a back view illustrating the tiltable portable baseball tee of FIG. 3;

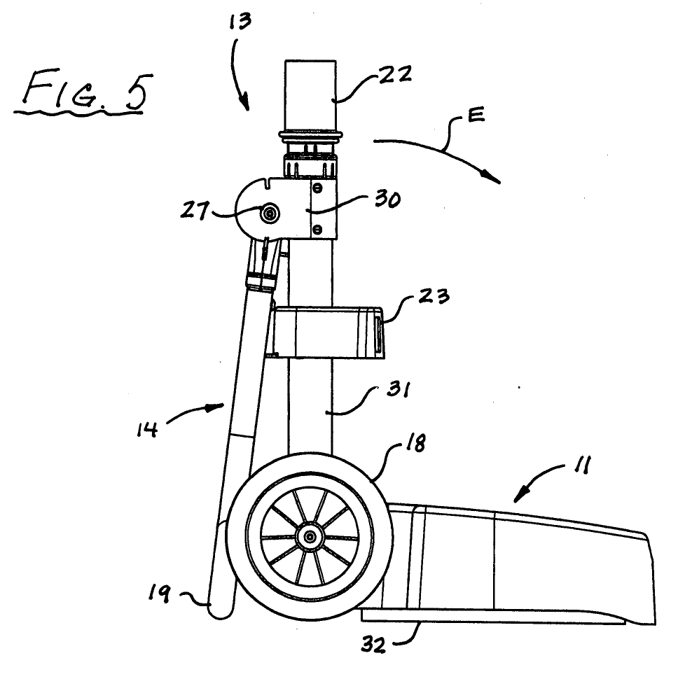

FIG. 5 is a side view illustrating the tiltable portable baseball tee of FIG. 3;

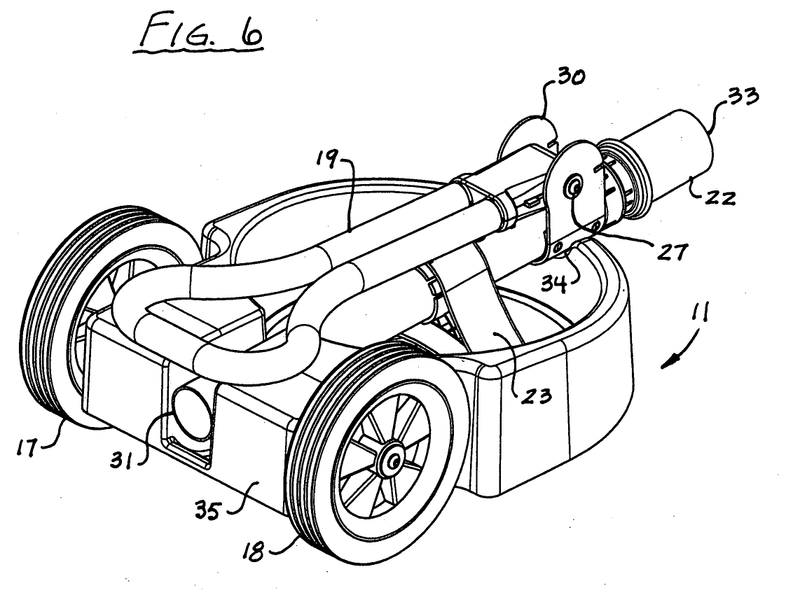

FIG. 6 is a perspective view illustrating the portable baseball tee of FIG. 3 with the telescoping tee in the stowed position;

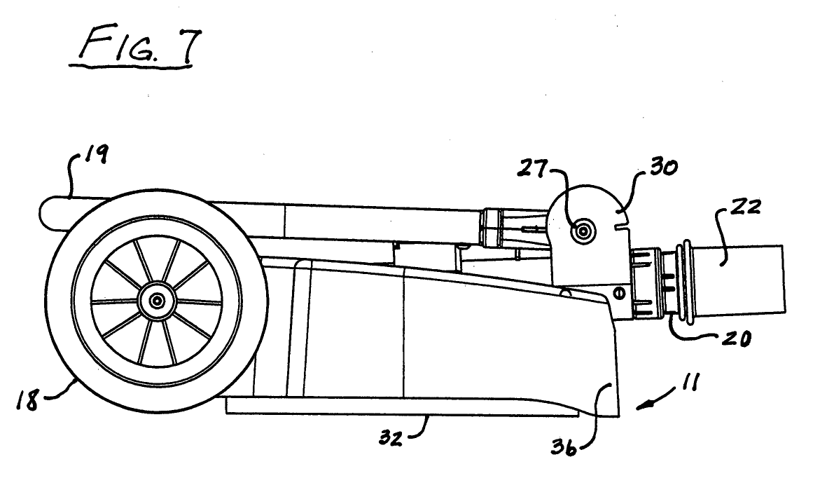

FIG. 7 is a side view illustrating the portable baseball tee of FIG. 6;

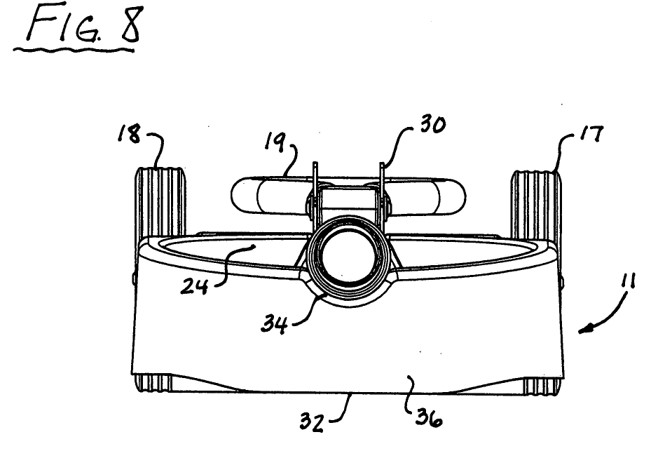

FIG. 8 is a front view illustrating the portable baseball tee of FIG. 6;

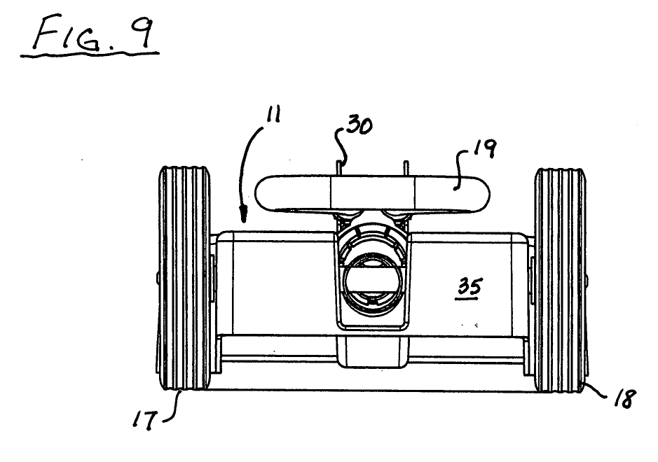

FIG. 9 is a back view illustrating the portable baseball tee of FIG. 6;

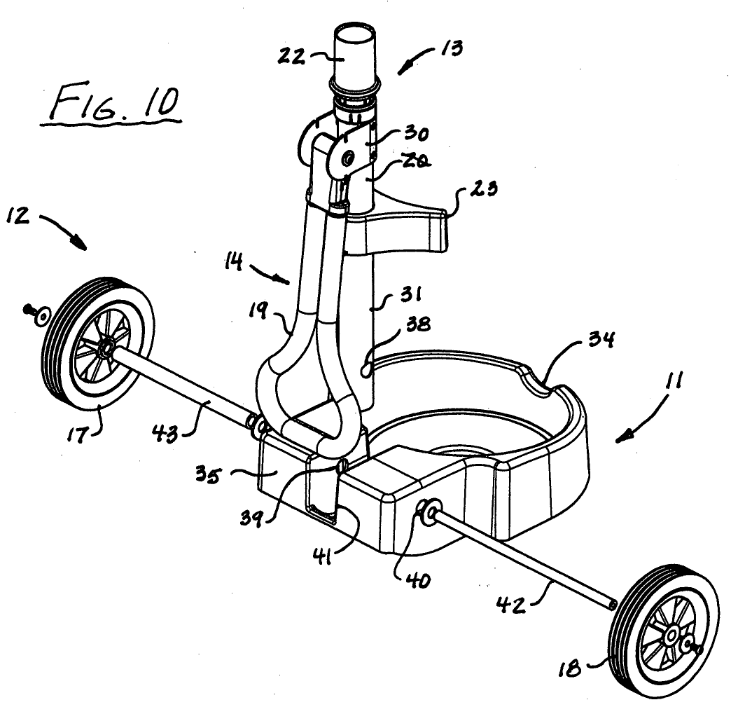

FIG. 10 is a perspective view illustrating the tiltable portable baseball tee of FIG. 3 with the wheel-axle assembly in exploded view;

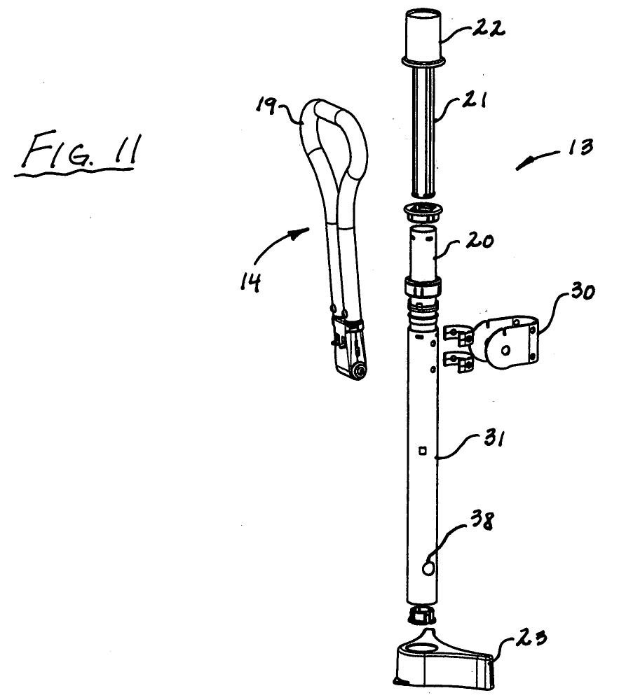

FIG. 11 is a perspective exploded view further illustrating the tee assembly of the tiltable portable baseball tee of FIG. 1; and,

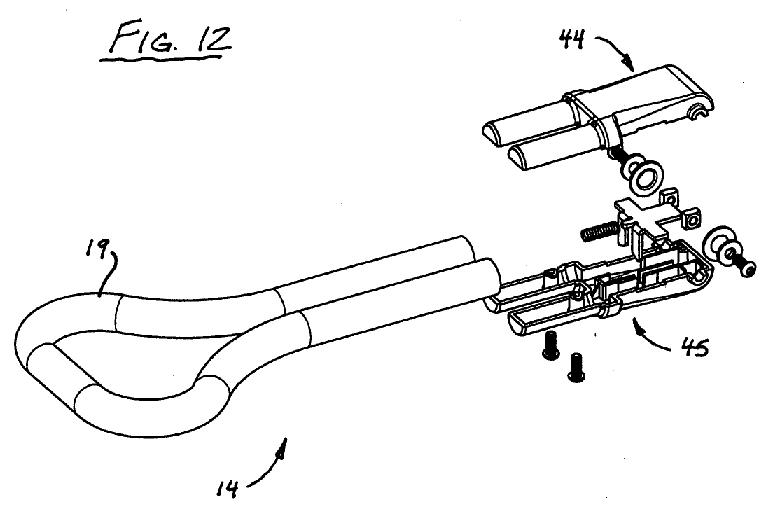

FIG. 12 is a perspective exploded view of a portion of the handle assembly of the tiltable portable baseball tee of FIG. 1.

Briefly, in accordance with the invention I provide an improved a tiltable portable baseball tee. The baseball tee includes a base shaped and dimensioned to removably receive and seat a bucket and having a front, a back, and a bottom; a bucket removably seated on said base; and, an axle-wheel assembly. The axle-wheel assembly is mounted on the back of the base; includes at least one ground engaging wheel mounted pivotally on said axle assembly; and, is shaped and dimensioned to permit the base to pivot thereabout between at least two operative positions, a first operative stationary position with the bottom contacting the ground, and a second transport operative position with the base and bottom of the base pivoted away from the ground such that ground engaging wheel can freely roll over the ground. The baseball tee also includes an upstanding batting tee-handle assembly mounted on the back of the base. The batting tee-handle is pivotable about the axle assembly simultaneously with the base; and, includes including a batting tee. The batting tee includes an adjustable member slidably movable between at least two operative positions, a first stowed operative position, and a second deployed position slid upwardly from the first stowed operative position. The batting tee also includes a handle used to tilt the base from the first operative stationary position to the second transport operative position and pull the baseball tee such that the wheel rolls freely over the ground. The baseball tee-handle assembly can be movable between at least two operative positions, a first operative deployed position extending upwardly from the base; and, a second operative stowed position folded downwardly from the first operative position and adjacent the base. The handle can be movable between at least two operative positions, a first operative deployed position extending outwardly from the batting tee; and, a second operative stowed position adjacent the batting tee. The baseball tee can include a strap to extend around and secure the bucket on the base adjacent the batting tee.

In another embodiment of the invention, we provide an improved method to practice skills used in playing the game of baseball. The method comprises the step of providing a tiltable portable baseball tee. The tee includes a base shaped and dimensioned to removably receive and seat a bucket and having a front, a back, and a bottom; and, includes an axle-wheel assembly. The axle-wheel assembly is mounted on the back of the base; includes at least one ground engaging wheel mounted pivotally on the axle assembly; and, is shaped and dimensioned to permit the base to pivot thereabout between at least two operative positions, a first operative stationary position with the bottom contacting the ground, and a second transport operative position with the base and bottom of the base pivoted away from the ground such that the ground engaging wheel can freely roll over the ground. The baseball tee also includes an upstanding batting tee-handle assembly mounted on the back of the base. The batting tee-handle assembly is pivotable about the axle assembly simultaneously with the base and includes a batting tee and a handle. The batting tee includes an adjustable member slidably movable between at least two operative positions, a first stowed operative position, and a second deployed position slid upwardly from the first stowed operative position. The handle is used to tilt the base from the first operative stationary position to the second transport operative position and pull the baseball tee such that the wheel rolls freely over the ground. The method also includes the steps of seating the bucket on the base; placing a plurality of baseballs in the bucket while said base is in the first operative position; grasping said handle and tilting the baseball tee from the first operative position to the second operative position, and pulling the baseball tee such that the wheel rolls freely over the ground, and to a first selected location; moving the baseball tee to a first selected location; tilting the baseball tee to the first operative position; moving the batting tee to the second deployed position; removing a baseball from the bucket and placing the baseball on the batting tee; and, hitting the baseball. The method can also include the additional steps of removing the bucket from the baseball tee; and, carrying the bucket to a second selected location.

Turning now to the drawings, which depict the presently preferred embodiments of the invention for the purpose of illustrating the practice thereof and not by way of limitation of the scope of the invention and in which like reference characters refer to corresponding elements throughout the several views, FIG. 1 illustrates a tiltable, portable adjustable separable foldable baseball tee constructed in accordance with the invention and generally indicated by reference character 10.

Baseball tee 10 includes base 11, bucket 15, wheel assembly 12, handle assembly 14, and hitting tee assembly 13. Wheel assembly 14 includes ground engaging wheels 17 and 18. Handle assembly 14 includes handle 14. Hitting tee assembly 13 includes top 22 with lip 33 shaped and dimensioned to seat a baseball, includes neck 21 slidably adjustable in sleeve 20 in the directions indicated by arrows A, includes collar 23 shaped to contact, laterally stabilize, and seat bucket 15. In FIG. 1, handle 19 is in the stowed position adjacent the hitting tee assembly and the back of base 11. The baseball tee 10 can include a strap 50 which extends around the hitting tee assembly 13 and bucket 15 to further secure bucket 15 in the batting tee. The strap can also extend from the collar 23 around the bucket, or from any desired location on the hitting tee assembly 13.

In FIG. 2, handle 19 has been pivoted upwardly about pin 27 in the direction of arrow H (FIG. 1) from the stowed position of FIG. 1 and is in the deployed position. A latch assembly, which can better be seen in FIG. 12, located at the proximate end of handle 19 secures handle 19 in the deployed position of FIG. 2. The latch assembly can be disengaged to permit handle 19 to pivot from the deployed position of FIG. 2 back to the stowed position of FIG. 1.

When handle 19 is in the latched deployed position of FIG. 2, the distal end of handle 19 can be grasped and displaced in the direction of arrow B to pivot simultaneously the base 11, handle assembly 14, and hitting tee assembly 13 about the axle-wheel assembly 12 to pivot and tilt the bottom 32 (FIG. 5) of base 11 upwardly away from the ground, typically so that bottom 32 is spaced apart from and at an angle in the range of ten to forty degrees with respect to the ground. After bottom 32 is pivoted and canted upwardly away from the ground, wheels 17 and 18 are the only parts of the baseball tee that contact the ground. At that point handle 19 can be pulled (or pushed) in the direction of arrow C or arrow D so that wheels 17 and 18 roll freely over the ground. When a desired location is reached, the baseball tee is stopped and handle 19 is utilized to pivot base 11, along with the handle assembly 14 and hitting tee assembly 13, about the axle-wheel assembly until bottom 32 is no longer tilted upwardly away from the ground and instead once again contacts the ground.

As can readily be seen in FIGS. 2 and 3, a well or inset is formed in base 11 to receive and seat the bottom of bucket 15. The well includes floor 25 and circular inner wall 24. Floor 25 and wall 24 circumscribe a generally cylindrical inner space 34. The well is slightly larger than and generally conforms to the bottom of bucket 15 so that when bucket 15 seats in the well, lateral movement of the bucket is generally prevented. Baseballs can be placed in bucket 15 before or after bucket 15 is seated in the well.

As is indicated in FIG. 5, the hitting tee assembly 13 can be pivoted in the direction of arrow E from the normal upright deployed position illustrated in FIGS. 1 to 5 to a stowed position illustrated in FIG. 6. In the stowed position, bracket 30 nests in detent 34 formed in base 11. FIGS. 7 to 9 also illustrate the hitting tee assembly 13 in the stowed position.

The wheel-axle assembly 12 is illustrated in more detail in the exploded view of FIG. 10 and includes the back of base 11. The back of base 11 includes vertically oriented surface 35. The bottom portion of the lower member 31 of the hitting tee assembly 13 is inserted in U-shaped opening 41 in the back of base 11 such that aperture 38 is in registration and aligned with apertures 39 and 40 extending through base 11. Inner axle member 42 slides into hollow outer axle member 43 such that both axle members 42, 43 extend through apertures 38, 39, 40. Wheels 17 and 18 are rotatably secured to the ends of axle members 42, 43 in conventional fashion in the manner illustrated in FIGS. 1 to 10. When hitting tee assembly 13 moves between the upright position of FIGS. 1 to 5 and the stowed position of FIGS. 6 to 9, aperture 38 pivots about the central portion of axle 43. Member 31 need not pivot about axle member 43 but can, if desired, pivot about another axle or member mounted in the back of base 11.

As illustrated in FIGS. 10 and 11, U-shaped bracket 30 pivotally secures the proximate, or lower, end of the handle assembly 14 to member 31 of the hitting tee assembly 13. Neck 21 is slidably received by sleeve 20. Sleeve 20 can, if desired, also be slidably received by member 31, or can be fixedly secured to member 31. Collar 23 is secured in a selected position on member 31 in the manner illustrated in FIGS. 1 to 6.

The lower, or proximate, end of handle 19 is secured in a releasable latch assembly in the manner indicated in FIG. 12. The latch assembly presently preferably releasably secures handle 19 both in the stowed position illustrated in FIG. 1 and the deployed position illustrated in FIG. 2.

Bucket 15 can be seated in the baseball tee 10 in the manner illustrated in FIG. 1 and transported with tee 10 when tee 10 is tilted and pulled (or pushed) over the ground. Or, bucket 15 can be removed from tee 10 so that tee 10 and bucket 15 can be transported to and used at different separate locations.

In use, baseball tee 10 is configured in the manner illustrated in FIG. 2. A bucket 15 is seated in the well in base 11. If there are no baseballs (or other practice balls) in bucket 15, a plurality of baseballs can, if desired, be placed in bucket 15. Handle 19 is grasped and hitting tee assembly 13 and base 11 are tilted in the direction of arrow B to tilt the bottom 32 of base 11 off the ground. Handle 19 is used to pull (or push) baseball tee 10 to a desired location. Baseballs or other practice balls are placed in or removed from bucket 15. Member 21 is slid up or down in the directions indicated by arrows A until top 22 is at a desired height above the ground. A baseball (not shown) is taken from bucket 15 and is placed on lip 33. A hitter hits the baseball with a bat and places a second baseball from bucket 15 (or from another source) on lip 33 and hits the second baseball. And so on.

An alternate use of the baseball tee 10 is to pull the baseball tee 10 around a baseball field to pick up baseballs.

A further use of the baseball tee 10 is for a coach to place it behind an L-screen, to remove balls from bucket 15, and to throw the baseballs to hitters during hitting practice.

A further use of the baseball tee 10 is to remove bucket 15 and for a hitter to use the baseball tee 10 at a first location to practice hitting while a coach or player carries bucket 15 to a second location at which balls are removed from bucket 15 and used in another drill, for example, a drill in which catchers block balls or a drill in which balls are hit to infielders.

In another embodiment of the invention, bucket 15 is replaced with a container of chalk that has a dispensing opening or mechanism in the container, and baseball tee 10 is pulled along the lines of a baseball field so that chalk dispensed from the container falls along and “chalks” the lines of a baseball field.

Unless reasons exist to the contrary, judicial notice is taken of the following facts:
1. There is, in the relevant market comprising teams and facilities to practice skills utilized in the game of baseball, a long felt dominant trend to carry manually buckets of balls used to practice hitting, fielding, and other skills.
2. There is, in the relevant market comprising teams and facilities to practice skills utilized in the game of baseball, a long felt dominant trend to carry manually hitting tees used to practice hitting.
3. There is, in the relevant market comprising teams and facilities to practice skills utilized in the game of baseball, a long felt dominant trend to carry buckets of baseballs utilizing the handle on the bucket.
4. There is, in the relevant market comprising teams and facilities to practice skills utilized in the game of baseball, a long felt dominant trend to utilize hitting tees which are not provided with a handle.
5. There is, in the relevant market comprising teams and facilities to practice skills utilized in the game of baseball, a dominant trend to use the bucket handle to carry a hitting tee when the hitting tee is combined with or carried in a bucket.
6. There is, in the relevant market comprising teams and facilities to practice skills utilized in the game of baseball, a dominant trend not to tilt a bucket of baseball during transport of the bucket.
7. There is no identified problem in the relevant market that provided sufficient impetus to develop the invention. Baseball buckets and hitting tees utilized in the relevant market have been accepted for many years.
8. There is no identified problem in the relevant market that suggests a readily apparent specific set of solutions, one of which is the invention.
9. There is no identified motivation in the relevant market that provided sufficient impetus for the development of the invention.
10. Common sense judgment requires that valid reasoning justifying such judgment be set forth.
11. The TSM test, per KSR, can provide helpful insight into evaluating the obviousness of the invention.
12. There is no reason not to use the TSM test in evaluating the obviousness of the invention described and claimed herein.
13. Motivation. Making something better is a broad, general, long-existing motivation that applies to each invention. Broad, general, long-existing motivations likely provide little significant impetus to produce an invention. For example, in the exercise machine art, one broad, general, long-existing motivation is to make exercise machines versatile, so that more than one exercise can be produced on an exercise machine. This motivation typically provides little significant impetus to produce an invention. If, on the other hand, an exercise machine produces a greater than normal number of injuries, such a problem is more specific and provides stronger impetus to improve the machine.
14. Assessing Weight Accorded a Problem or Motivation. The weight or importance of a problem or motivation in leading to an invention is apprised by evaluating by (1) how long the problem has existed, (2) the importance, and hence the driving force, of the problem or motivation, (3) whether the problem or motivation reasonably suggests the invention, (4) whether the motivation reasonably suggests a set of solutions of which the invention is one, (5) the trends, if any, produced by the problem or motivation, and (6) other solutions produced in response to the motivation or problem. With respect to (1) above in this paragraph, if a problem has long existed without producing a solution, that suggests the invention is not obvious. With respect to (2) above in this paragraph, if the problem appears to have little significance, that suggests it is not driving those of skill in the art toward the invention. With respect to (3) above, if the problem suggests a solution other than the invention, this suggests the problem is not driving those of skill in the art toward the invention. With respect to (4) above in this paragraph, if the problem suggests a set of solutions other than the invention, this suggests the problem is not leading toward the invention. With respect to (5) above, if the prevailing trends lead away from the invention or reinforce other solutions to the invention, that suggests the problem has not presented the invention as a solution. With respect to (6) above in this paragraph, other solutions may reinforce the idea that the art is satisfied with the status quo and not interested in alternate solutions.
15. Common Sense. Proposed definitions of common sense are set forth below.

A. The People In Common (PIC) Definition: “The earth is flat”.

One definition of common sense is what people in common would agree upon, that which they “sense” as their common natural understanding or would consider in most people's experience to be prudent and of sound judgment. This definition assumes a country with a population with a particular baseline language, customs and knowledge. The baseline knowledge is knowledge available and known by a large majority of the population, and is knowledge that typically does not require specialized knowledge or study; such baseline knowledge can change over time depending on the success of educational institutions, changing societal climes, etc. Under the people in common (PIC) definition, common sense often has been wrong and, for example, at one time held that the earth was flat. Even today it evidently is estimated that 60% of the people on earth believe the sun revolves around the earth. Others today use “common sense” to make the judgment that heavier bodies fall faster than light bodies.

B. The Common Man Sound Judgment (CMSJ) Definition.

A second definition of common sense is sound judgment based on a simple perception of the situation or facts. Sound judgment means sensible judgment based on valid reasoning. This suggests that a common sense judgment, if reliable, is subject to evaluation to see if there are reasons or criteria that support and justify the judgment. This definition assumes a country with a population with a particular baseline language, customs and knowledge. The baseline knowledge is knowledge available and known by a large majority of the population, and is knowledge that typically does not require specialized knowledge or study; such baseline knowledge can change overtime depending on the success of educational institutions, changing societal climes, etc. What might be common sense to an American might not be common sense to a person living in another country. An individual could move to the United States from India and what might appear common sense to an American would, because of the culture of India, make absolutely no sense to the Indian. In evaluating obviousness, however, it is usually, for better or worse, assumed that the Indian has the same baseline knowledge as individuals who have grown up in the United States.

C. The Ordinary Skill Sound Judgment (OSSJ) Definition.

A third definition of common sense is sound judgment by one of ordinary skill in the art based on a perception of the situation or facts in the context of the baseline knowledge in CMSJ and of specialized knowledge that is over and above said baseline knowledge and is attributed to one of ordinary skill in the art. As noted, sound judgment means sensible judgment based on valid reasoning. This suggests that a common sense judgment by one or ordinary skill in the art is, if reliable, subject to evaluation to see if there are reasons or criteria that support and justify the judgment. This definition assumes a country with a population with a particular baseline language, customs and knowledge. The baseline knowledge and specialized knowledge comprise knowledge available and known by a large majority of those of skill in the art; such baseline knowledge and specialized knowledge can change over time depending on the success of educational institutions, advances in the art, changing societal climes, etc. What might be common sense to an American of ordinary skill in the art might not be common sense to a person that lives in another country and appears to be one of ordinary skill in the art. In evaluating obviousness, however, it is usually, for better or worse, assumed that the person of ordinary skill in the art from India has the same baseline knowledge as individuals of skill in the art who have grown up in the United States. In some technically simple inventions, the ordinary skill sound judgment (OSSJ) may be commensurate with common man sound judgment (CMSJ) because there is little if any specialized knowledge required. For example, a new Christmas tree ornament design might not require any particular specialized knowledge over and above the baseline knowledge of the large majority of people. In contrast, many inventions obviously require a specialized knowledge over and above commonly held baseline knowledge, in which case such specialized knowledge will be utilized in the sound reasoning involved in ordinary skill sound judgment common sense.

As used herein, relying on common sense judgment requires that valid reasoning justifying such judgment be set forth. Hence, the common man sound judgment (CMSJ) and ordinary skill sound judgment (OSSJ) definitions are generally relied on herein in determining the obviousness of an invention.
16. Assessment of Trends. As used herein a trend is a general inclination or tendency. A trend generally (1) occurs over an extended period of time, (2) occurs by or within a large number of individuals in the pertinent art, and (3) often can be demonstrated by the existence of a significant number of printed references and by personal knowledge of those in the art. With respect to (1) above in this paragraph, a general inclination that lasts a short period of time, for example a day or a month, typically does not constitute a trend. With respect to (2) above in this paragraph, if only a few individuals demonstrate a general inclination or tendency, such typically does not comprise a trend. With respect to (3) above in this paragraph, if there are only a few documents that demonstrate a particular inclination or tendency, such typically does not demonstrate a trend.

The weight or importance of a trend in leading to an invention is evaluated by assessing (1) the length of time during which the trend has existed, (2) the number of individuals that believed or followed the trend, (3) the number of references that describe the trend, (4) the existence of other similar or related trends that might obfuscate or invalidate a trend and make it unlikely to lead to the invention, and (5) the existence of countervailing trends. If a trend is “buried” among many comparable trends in the art, it becomes more unlikely that one of ordinary skill will notice or utilize the trend. If a trend is overshadowed by countervailing trends, it becomes more unlikely that one of ordinary skill will notice or utilize the trend.
17. Assessing an Equivalent. As used herein, an equivalent is a structure or a system that is functionally or structurally equivalent to another structure or system. In determining whether it is obvious to substitute one “equivalent” for another, the following must be evaluated. First, is what is being substituted truly an equivalent? Is it functionally or structurally equivalent to what is being replaced? Second, if the equivalent is functionally or structurally equivalent, is it only structurally equivalent or only functionally equivalent? If it is only one or the other, this reduces the likelihood the equivalent would be used. Third, did the equivalent, or the invention, have to be modified to use the equivalent? If so, this reduces the likelihood the equivalent would be utilized. Fourth, is it likely the equivalent would be considered by one of ordinary skill in the art? If a new Christmas ornament utilizes a laminate including an outer protection coating from a prior Christmas ornament and substitutes that coating as an “equivalent” for the outer protective coating in another known Christmas ornament, then it arguably is likely that such a substitution would be considered by one of skill in the art. On the other hand, if the first substitute coating is normally found in a nuclear reactor in a submarine, it may be very unlikely, almost incredible, that such a coating would be considered and a substitution would be made. Simply stating that it would be known by one of skill in the art to substitute an equivalent is not, without providing reasons, believed sufficient. Otherwise such a generalized rationale could be used to invalidate most, if not all, patents known to man.

Having set forth our invention in terms to enable those skilled in the art to understand and practice the invention and having set forth the presently preferred embodiments and uses thereof, We claim:

1. A tiltable portable baseball tee including
(a) a base shaped and dimensioned to removably receive and seat a bucket and having a front, a back, and a bottom;
(b) a bucket removably seated on said base;
(c) an axle-wheel assembly
(i) mounted on said back of said base,
(ii) including at least one ground engaging wheel mounted pivotally on said axle assembly,
(iii) shaped and dimensioned to permit said base to pivot thereabout between at least two operative positions,
a first operative stationary position with said bottom contacting the ground, and
a second transport operative position with said base and bottom of said base pivoted away from the ground such that said ground engaging wheel can freely roll over the ground;
(d) an upstanding batting tee-handle assembly mounted on said back of said base, said batting tee-handle
(i) pivotable about said axle assembly simultaneously with said base,
(ii) including
a batting tee including an adjustable member slidably movable between at least two operative positions,
a first stowed operative position, and
a second deployed position slid upwardly from said first stowed operative position, and
a handle used to tilt said base from said first operative stationary position to said second transport operative position and pull said baseball tee such that said wheel rolls freely over the ground.

2. The baseball tee of claim 1 wherein said batting tee-handle assembly is movable between at least two operative positions
(a) a first operative deployed position extending upwardly from said base; and,
(b) a second operative stowed position folded downwardly from said first operative position and adjacent said base.

3. The baseball tee of claim 1 wherein said handle is movable between at least two operative positions,
(a) a first operative deployed position extending outwardly from said batting tee; and,
(b) a second operative stowed position adjacent said batting tee.

4. The baseball tee of claim 1 including a strap to extend around and secure said bucket on said base adjacent said batting tee.

5. A method to practice skills used in playing the game of baseball, comprising the steps of
(a) providing a tiltable portable baseball tee including
(i) a base shaped and dimensioned to removably receive and seat a bucket and having a front, a back, and a bottom,
(ii) an axle-wheel assembly
mounted on said back of said base,
including at least one ground engaging wheel mounted pivotally on said axle assembly,
shaped and dimensioned to permit said base to pivot thereabout between at least two operative positions,
a first operative stationary position with said bottom contacting the ground, and
a second transport operative position with said base and bottom of said base pivoted away from the ground such that said ground engaging wheel can freely roll over the ground;
(iii) an upstanding batting tee-handle assembly mounted on said back of said base, said batting tee-handle assembly
pivotable about said axle assembly simultaneously with said base, including
a batting tee including an adjustable member slidably movable between at least two operative positions,
a first stowed operative position, and
a second deployed position slid upwardly from said first stowed operative position, and
a handle used to tilt said base from said first operative stationary position to said second transport operative position and pull said baseball tee such that said wheel rolls freely over the ground;
(b) seating said bucket on said base;
(c) placing a plurality of baseballs in said bucket while said base is in said first operative position;
(d) grasping said handle;
(i) tilting said baseball tee from said first operative position to said second operative position;
(ii) pulling said baseball tee
such that said wheel rolls freely over the ground, and to a first selected location;
(e) moving said baseball tee to a first selected location;
(f) tilting said baseball tee to said first operative position;
(g) moving said batting tee to said second deployed position;
(h) removing a baseball from said bucket and placing the baseball on the batting tee; and,
(i) hitting the baseball.

5. The method of claim 5 including
(a) removing the bucket from the baseball tee; and,
(b) carrying the bucket to a second selected location.
